(19) United States
(12) Patent Application Publication
(10) Pub. No.: US 2007/0126225 A1
(43) Pub. Date: Jun. 7, 2007

(54) Repositionable insert

(76) Inventors: Edward P. Busam, Mason, OH (US); Lisa K. Brooks, West Chester, OH (US); Sun-Jan Alan Huang, Columbus, OH (US); Diana Juratovac, Columbus, OH (US)

Correspondence Address: THOMPSON HINE L.L.P., P.O. BOX 8801, DAYTON, OH, 45401-8801, US

(21) Appl. No.: 11/541,896

(22) Filed: Oct. 2, 2006

Related U.S. Application Data
(63) Continuation-in-part of application No. 11/293,994, filed on Dec. 5, 2005.

(51) Int. Cl. B42D 5/04

(52) U.S. Cl. 283/2

(57) ABSTRACT

A calendar system including a bound component having a plurality of sheets of paper and a binding mechanism binding the plurality of sheets together. Each sheet includes a calendar portion printed thereon, with each calendar portion of each sheet being of substantially the same size and format. The system further includes a generally translucent insert configured to be directly releasably coupled to the binding mechanism such that the insert is positionable on top of one of the sheets such that the calendar portion of the underlying sheet is visible through the insert. The system includes a permanent writing instrument configured to dispense permanent markings on the insert when the insert is written upon by the writing instrument, and erasing means for erasing permanent markings from the insert. The writing instrument is operable to write indicia on the insert such that the indicia written on the insert is usable in conjunction with calendar portions of various ones of the sheets when the insert is attached to the binding mechanism and positioned on top of various ones of the sheets.

This application is a continuation-in-part application of U.S. patent application Ser. No. 11/293,994, filed on Dec. 5, 2005, the entire contents of which are hereby incorporated by reference.

The present invention is directed to an insert, and, more particularly, to an insert that can be coupled to a bound component.

### BACKGROUND

Bound components, such as journals, diaries, date books, address books, notebooks, planner, calendars, binders and the like are used to store papers, information and the like. Users may wish to write reminders or other indicia in these bound components.

In addition, when the bound component is a planner, date book, calendar or the like, the reminders or indicia may be recurring. In this case, it may be desired to ensure that the recurring reminders or indicia are displayed on or in conjunction with the appropriate date. Accordingly, there is a need for an improved repositionable insert which can be written upon.

### SUMMARY

In one embodiment, the invention is a calendar system including a bound component having a plurality of sheets of paper and a binding mechanism binding the plurality of sheets together. Each sheet includes a calendar portion printed thereon, with each calendar portion of each sheet being of substantially the same size and format. The system further includes a generally translucent insert configured to be directly releasably coupled to the binding mechanism such that the insert is positionable on top of one of the sheets such that the calendar portion of the underlying sheet is visible through the insert. The system includes a permanent writing instrument configured to dispense permanent markings on the insert when the insert is written upon by the writing instrument, and erasing means for erasing permanent markings from the insert. The writing instrument is operable to write indicia on the insert such that the indicia written on the insert is usable in conjunction with calendar portions of various ones of the sheets when the insert is attached to the binding mechanism and positioned on top of various ones of the sheets.

In another embodiment the invention is a system including a bound component having a plurality of sheets of paper and a binding mechanism binding the plurality of sheets together. The system further includes an insert configured to be directly releasably coupled to the binding mechanism such that the insert is positioned on top of one of the sheets and substantially entirely covers the underlying sheet. The system includes a permanent writing instrument configured to dispense permanent markings on the insert when the insert is written upon by the writing instrument, and erasing means for erasing permanent markings from the insert.

### BRIEF DESCRIPTION OF THE DRAWINGS

FIG. 1 is a front perspective view of one embodiment of the bound component of the present invention, shown in its closed position;

FIG. 2 is a front perspective view of the bound component of FIG. 1, shown in its open position;

FIG. 3 is a front perspective view of the bound component of FIG. 2, with an insert positioned to be coupled thereto;

FIG. 4 is a front perspective view of the bound component of FIG. 3, with the insert coupled thereto;

FIG. 5 is a front perspective view of the bound component of FIG. 4, with the insert being written upon by a marker;

FIG. 6 is a front perspective view of the bound component of FIG. 5, with the insert exploded away;

FIG. 7 is a front perspective view of the bound component of FIG. 6, with the insert moved to a different location in the bound component;

FIG. 8 is a front perspective view of the bound component of FIG. 7, with the writing on the insert being erased by the marker; and

FIG. 9 is a top view of the insert of FIG. 3.

### DETAILED DESCRIPTION

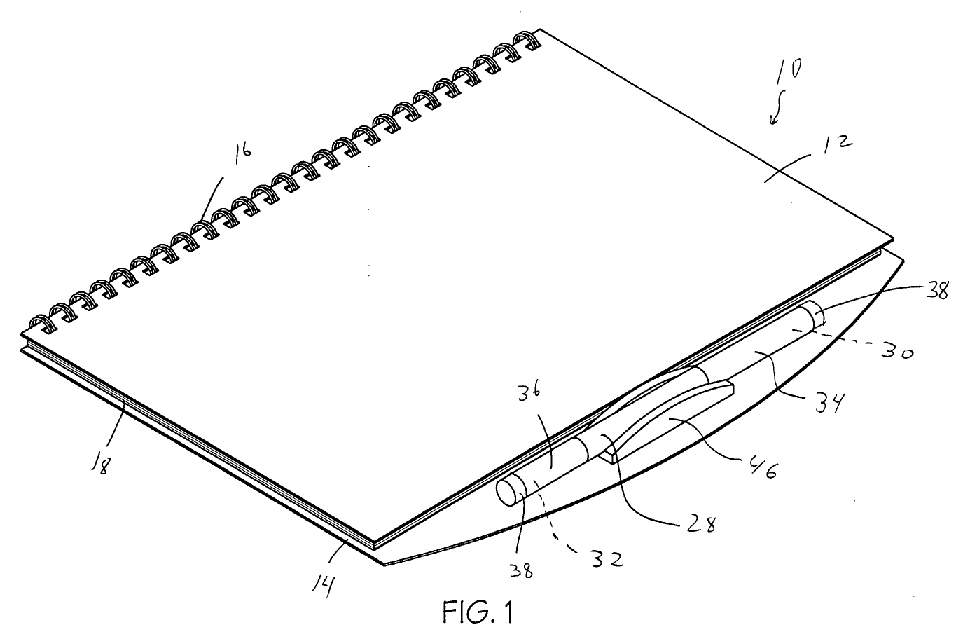

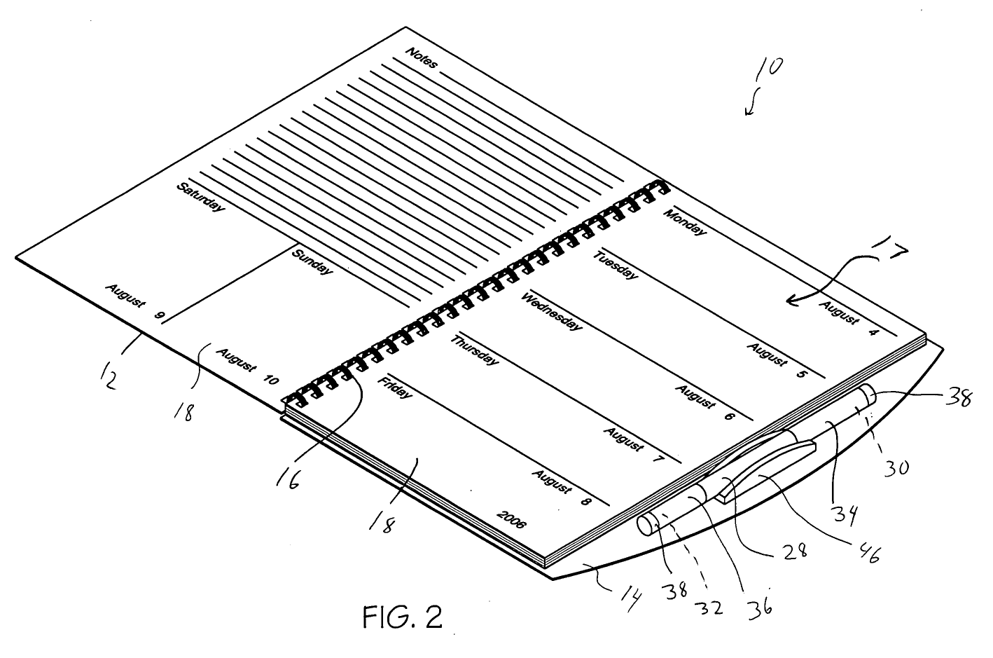

As shown in FIGS. 1 and 2, in one embodiment the bound component 10 of the present invention includes a front cover 12 and rear cover 14 coupled together by a binding mechanism 16. In the illustrated embodiment, the binding mechanism 16 takes the form of a coil wire or spiral wire binding mechanism. However, the binding mechanism 16 may take any of a variety of forms including prongs, clips, adhesive binding mechanisms, book-style binding mechanisms, three-ring binding mechanisms or the like.

The binding mechanism 16 binds a plurality of bound papers, pages or sheets 18 together and to the covers 12, 14. Each bound page 18 may be made of generally water absorbent material such as cellulose-based or pulp-based paper to allow user to write information thereon with a wide variety of writing instruments or media such as pens, pencils, markers, highlighters and the like. In the illustrated embodiment, each of the bound pages 18 includes calendar indicia 17 printed on one or both sides thereof. In this case, the bound component 10 may operate as a planner, date book or calendar. However, each of the pages 18 can be printed with various other decorative or functional indicia, or may be simply blank or lined.

The front 12 and rear 14 covers may each have a stiffness and/or thickness greater than each of the bound pages 18 to provide protection to the pages 18. For example, the covers 12, 14 may be made of cardboard, paperboard, plastic, a combination of these materials, or the like.

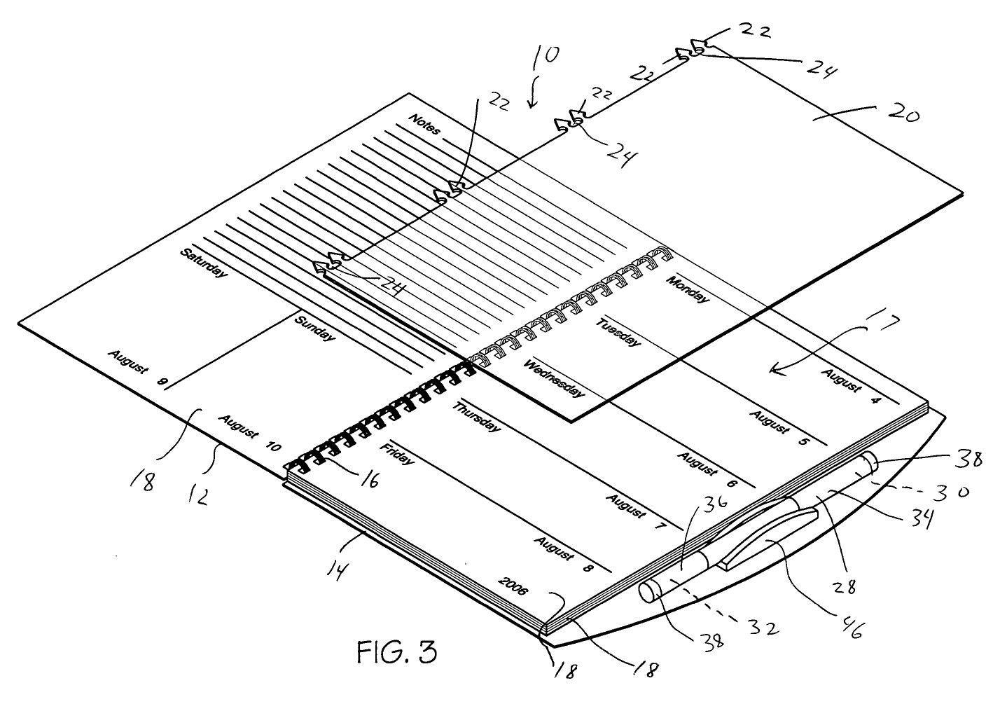

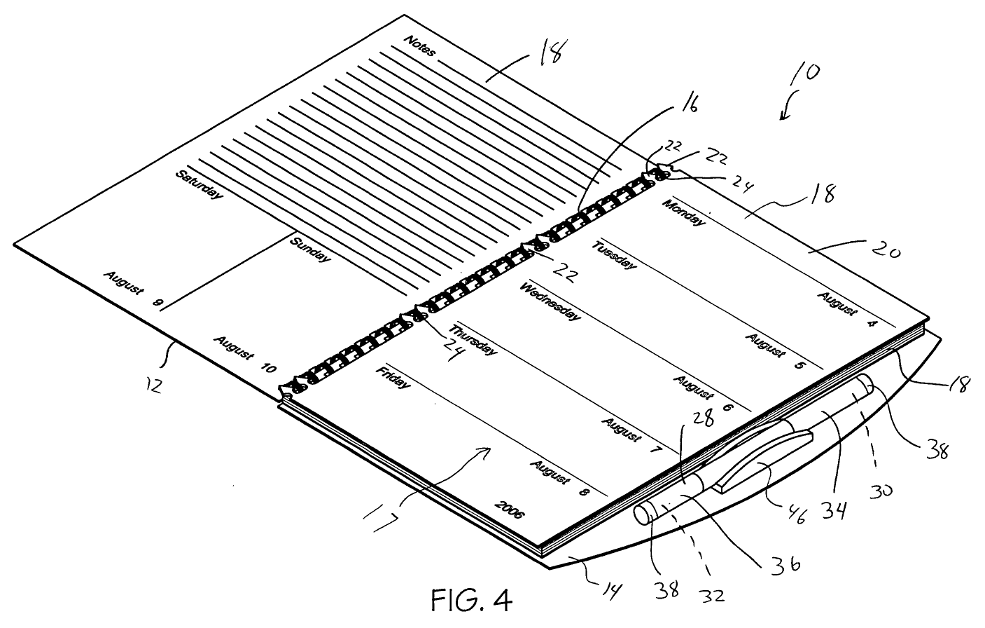

As shown in, for example, FIGS. 3 and 4, the bound component 10 may include or utilize a divider or insert 20. The insert 20 may be made of a generally transparent or translucent material to allow any text, drawings or other indicia (i.e., such as the calendar indicia 17) to be viewable through the insert. The insert 20 may be relatively thin, for example, less than about 0.5 mm thick or less than about 0.25 mm thick. The insert 20 may be configured to be directly releasably coupled to the binding mechanism 16.

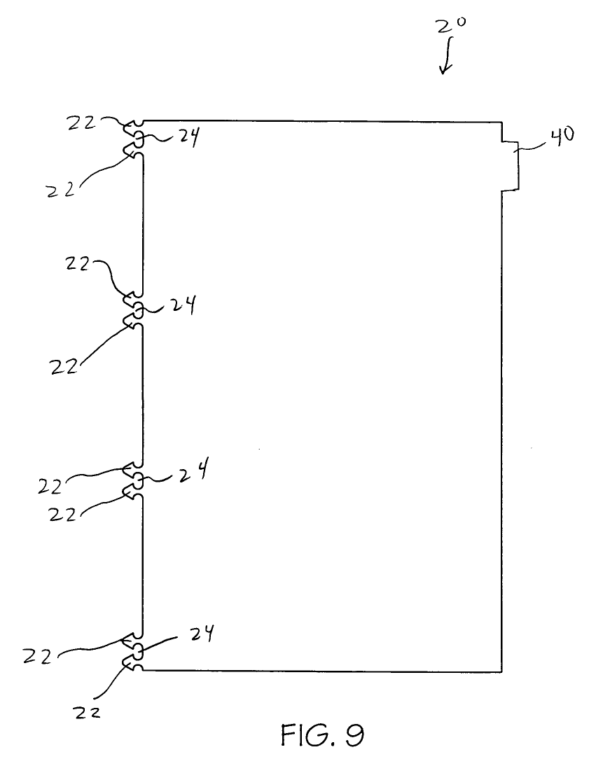

For example, as shown in FIG. 9, the insert 20 may include a plurality pairs of generally arrow-tip shaped or barbed protrusions 22 along its inner edge. Each pair of protrusions 22 defines an opening 24 therebetween, with each opening 24 being configured to receive at least one turn of the coil wire or spiral wire binding mechanism 16 therein. The angled tips of the protrusions 22 help to guide the wires/turns of the binding mechanism 16 into the associated openings 24 and retain them therein until the insert 20 is sufficiently pulled upon by a user.

However, the insert 20 may include a variety of structures and components (besides the protrusions 22/openings 24) for releasably attaching the insert 20 to the binding mechanism 16. For example, the insert 20 may simply include a plurality of openings or slots, each of which receives a turn or turns of the binding mechanism 16 therein or therethrough, or other parts of the binding mechanism 16 therein or therethrough. Further alternately, the insert 20 may include other types of protrusions which cooperate with the binding mechanism 16 to releasably attach the insert 20 to the binding mechanism 16.

In addition, the structure 22 for attaching the insert 20 to the binding mechanism 16 as shown in the drawings is specifically configured for use with a coil or spiral binding mechanism 16. However, it should be understood that the structure for releasably attaching the insert 20 to the binding mechanism will, of course, differ depending upon the type of binding mechanism utilized.

The bound component 10 may include, or be used in conjunction with, a marker or writing instrument 28. The marker 28 includes a first, or marking, tip 30 located at one end and a second, or erasing, tip 32 located at an opposite end thereof. The tips 30, 32 may be made from a wide variety of materials, such as felt. Although the marker 28 is illustrated as having a tip 30, 32 at each end, the marker 28 may have a wide variety of other configurations for the tips 30, 32, including having the tips 30, 32 being oriented at various angles, being located in a side-by-side configuration, having only a single tip, etc.

The first tip 30 is configured to dispense a permanent or indelible ink solution of any of a wide variety of colors. The permanent ink or permanent ink solution dispensed by the first tip 30 may be nearly any type of permanent ink or ink solution, such as a traditional organic solvent based permanent ink with a wide variety of pigments, dye, colorants or the like, or an aqueous type permanent ink as described in U.S. Pat. No. 5,131,776, the entire contents of which are hereby incorporated by reference. The permanent ink may be an alcohol (i.e. n-propyl alcohol) based or other organic solvent based permanent ink. The permanent ink may be capable of marking on porous surfaces (e.g., paper, wood and the like) and nonporous surfaces (e.g., glass, metal, plastic and other polymer based surfaces). Further, the permanent ink may be resistent to smearing and re-wetting after application and may resist emulsification, dissolving or removal with soap and water.

The second tip 32 is configured to dispense a solvent that can dissolve the permanent ink or ink solution dispensed by the first tip 30. The solvent may be any solvent that is capable of solubilizing or dissolving permanent ink or a permanent ink solution that has been applied to a surface and allowed to dry. The solvent may be or include an ethyl alcohol, an n-propyl alcohol, or other organic based solvents.

The permanent ink solution may be soaked through, or wicked to, the first tip 30 such that when the first tip 30 contacts a substrate to be written upon, ink is deposited on the substrate. Similarly, the solvent is wicked to the second tip 32 such that when the second tip 32 contacts the substrate, solvent from is deposited onto the substrate and solubilizes (or dissolves) any ink deposited by the first tip 30, and contacted by the solvent. Thus the marker 28 may be a double-ended felt-tip marker, although the marker 28 may include various other manners of dispensing the permanent ink and solvent, such as ball-point dispensers, gel-type dispensers, etc.

The marker 28 may include a cap 34 for covering the marking tip 30 and a cap 36 for covering the erasing tip 32. The caps 34, 36 prevent the ink and solvent from evaporating through the associated tip 30, 32 when the marker 28 is not in use. The caps 34, 36 may be shaped to form a tight interference fit or seal with the marker 28 to seal off the associated tip 30, 32. One or both caps 34, 36 may also include an absorbent portion 38 located, for example, on an outer surface of the cap 34, 36. The absorbent portion 38 may be made of a felt, cotton, foam, sponge-type material or other absorbent material. The absorbent portion 38 may be used to wipe away markings that are deposited by the writing tip 30 and erased/dissolved by the erasing tip 32.

When the insert 20 is used in conjunction with a planner, date book or calendar (i.e., if the pages 18 have a calendar portion printed thereon), the insert 20 may be generally transparent or translucent, and may be positioned on top of a page 18 and substantially cover an associated page 18 as shown in FIG. 4. However, at least the calendar portion 17 of each page 18 may be entirely or substantially visible through the insert 20. The insert 20 may have a height and/or width that is substantially the same as the height and width of the associated pages 18. Alternately, the insert 20 may have a height and/or width that is at least about 80%, or at least about 90%, of the associated height and/or width of the associated pages 18. The insert 20 may include a tab portion 40 (FIG. 9) that protrudes outwardly from the stack of pages 18 when the insert 20 is coupled to the binding mechanism 16 such that the insert 20 can be easily located and accessed. More particularly, the plurality of pages 18 have a width dimension extending generally perpendicular to the binding mechanism 16, and the insert 20 may have a tab portion 40 configured such that the tab 40 protrudes outwardly from the plurality of pages 18 when the insert 20 is directly coupled to the binding mechanism 16.

In order to ensure proper operation in conjunction with the marker 28, the insert 20 may be made entirely or partially of a plastic or polymer material such as polypropylene, polyethylene or the like that is capable of being marked upon in a lasting manner using permanent ink, but not with typical water based inks. The insert 20 may have a glossy finish surface and/or a UV aqueous coating and/or other coatings. The insert 20 may be made of a material that is chemically resistant to any solvents dispensed by the marker 28 (i.e., erasing solution).

Further, the insert 20 may have a slightly roughened surface with creases and recesses sufficient to absorb or receive ink in the creases and recesses to aid in retaining the ink thereon, but not exceedingly rough to make it overly difficult to remove the ink. In one embodiment, the insert 20 has an average surface roughness of between about 9 and about 1000 microns, or between about 500 and about 1000 microns, or between about 9 and about 100 microns. The insert 20, permanent ink and solvent should be selected such that application of the permanent ink or solvent to the insert 20 does not significantly irreversibly alter, destroy or marr the insert 20. Proper selection may allow the insert 20 to be used many times over for marking and erasing. Accordingly the insert 20 can be reused and updated, for example, to update a to-do list. If desired, one or both of the covers 12, 14 may have the same qualities as the materials of the insert 20 such that the covers 12, 14 can be written upon by the marker 28, and the permanent markings can be erased by the marker 28.

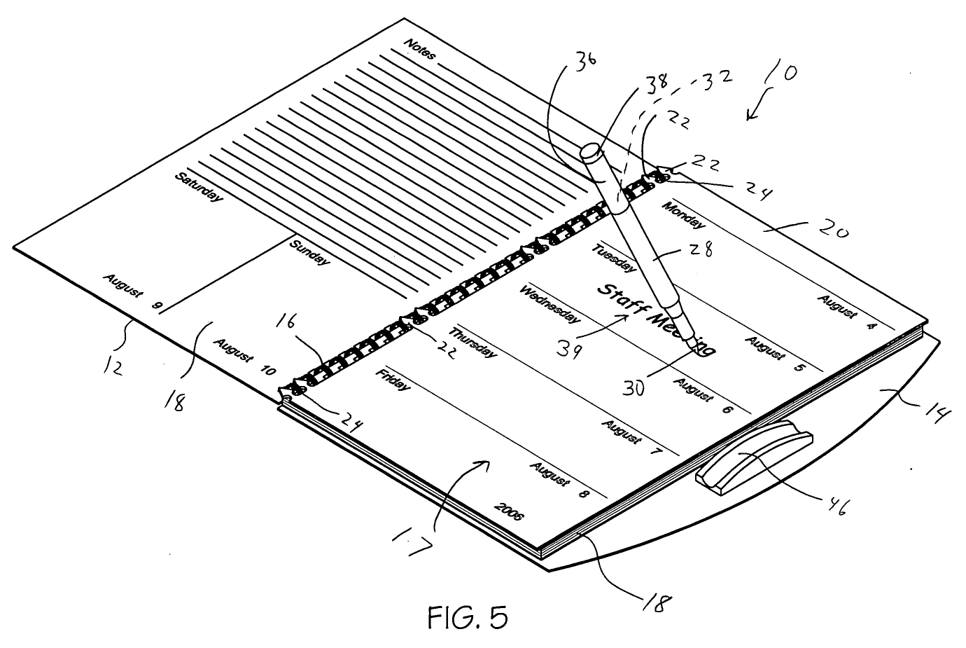

As shown in FIG. 5, a user may mark various indicia or markings 39 on the insert 20 using the writing tip 30 of the marker 28. For example, as noted above when the bound component 10 is a planner, date book or calendar and the insert 20 is transparent, the insert 20 may be positioned on top of a page 18 with a calendar portion 17 such that the calendar portion 17 of the underlying page 18 is visible therethrough. The marker 28 is then used to make markings on the insert 20. The markings can be general notes or reminders, and may take the form of a “to-do” list. Alternately, the marking can relate to a specific event associated with a specific date or dates. For example, in FIG. 5 the markings 39 takes the form of a reminder of a staff meeting for Tuesday, August 5.

The markings 39 may then be allowed to dry. Once dry, the markings 39 may not be able to be erased by simply rubbing the markings by hand, or with soap and water or the like. The markings 39 may then be allowed to remain in place for as long as desired.

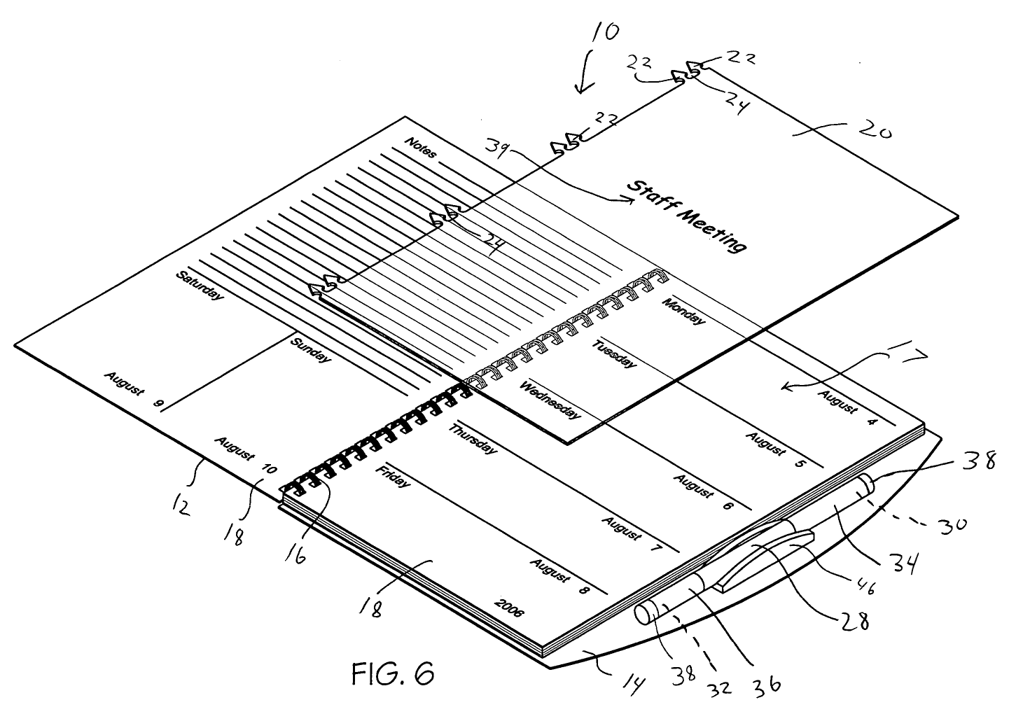

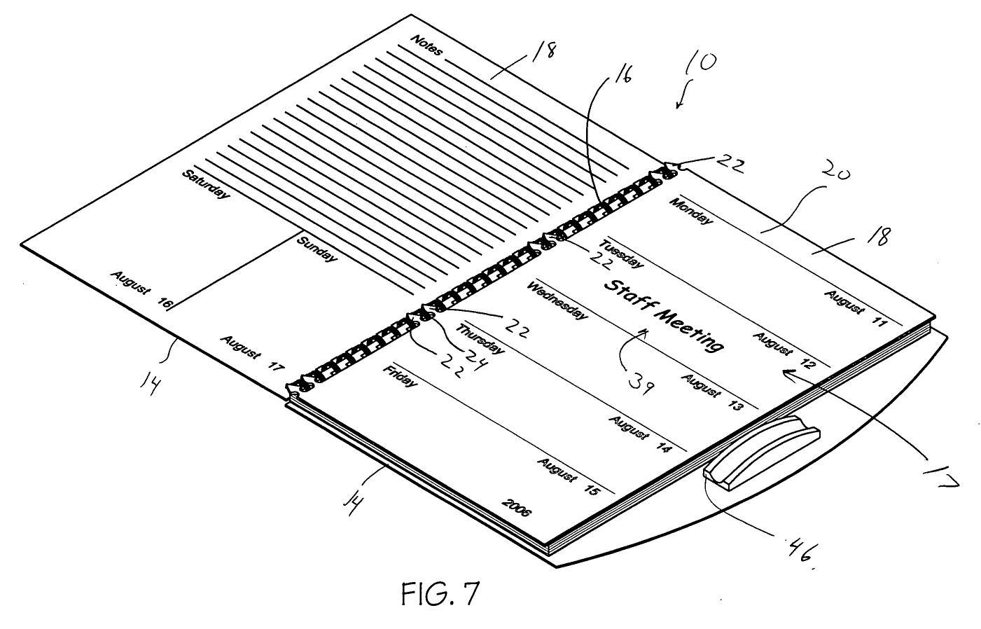

In addition, the insert 20 can be re-positioned within the bound component 10. For example, once the relevant time period displayed in the bound component 10 (for example, the dates shown in FIG. 5) have passed, the insert 20 can be removed from the binding mechanism 16 (FIG. 6), re-positioned in the bound component 10 in the next consecutive time period (as shown in FIG. 7) on the next page 18. In this manner, any notes, reminders, lists or the like on the insert 20 are retained.

In addition, the calendar format on each page 18 may be generally the same. In this manner, a reminder written on the insert for a specific day (i.e. Tuesday, in the embodiment shown in FIGS. 5-7) is always properly positioned (i.e. located on top of or within the bounds of the associated date or time period) with respect to the appropriate day (i.e., Tuesday) on each page 18. In this manner, recurring reminders (i.e., a staff meeting on each Tuesday) can be easily tracked without having to re-write the reminder over time.

It should be noted that the recurring nature of the reminders can be carried over to other time periods, besides specific days of the week. For example, each page 18 may present a day broken down into hourly time periods, and the recurring reminder may be used for a specific hour of the day. Further alternately, each page 18 may present a month-long calendar, and the recurring reminder may be provided for a specific day of the month.

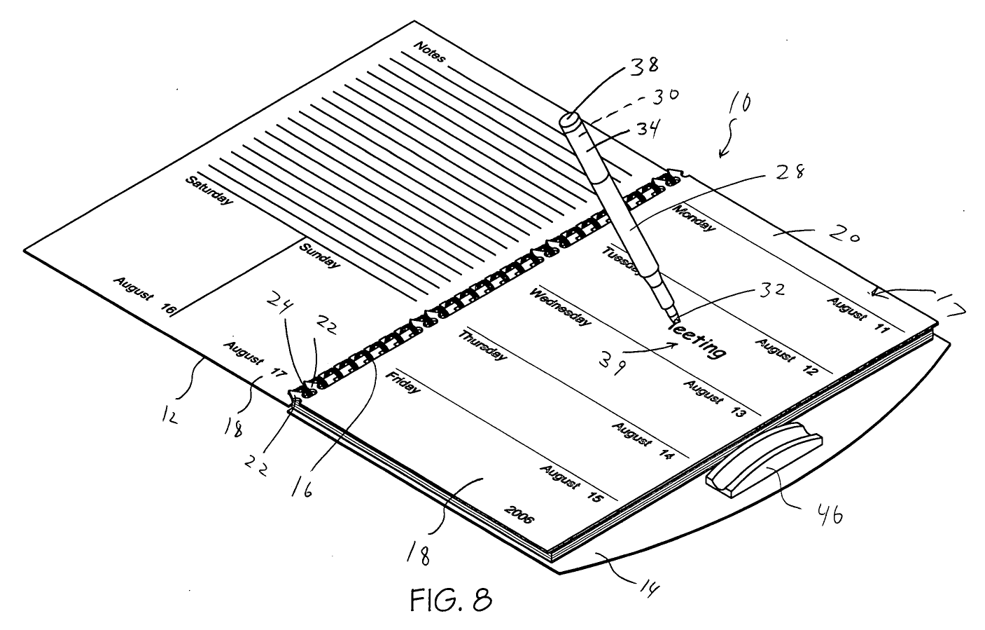

When it is desired to erase the markings 39, the erasing tip 32 is applied to the markings 39 to solubilize/erase/dissolve the markings 39 as shown in FIG. 8. The erasing tip 32 may be moved over the markings 39 such that the solvent contacts the deposited markings 39 and solubilizes the markings 39, thereby allowing the markings 39 to be erased. A user may then utilize either cap 34, 36 (or other absorbent material) and apply the absorbent portion 38 to the insert 20 to wipe away or absorb the solubilized markings.

The bound component 10 may be configured to releasably receive the marker 28 therein or thereon. In particular, in the illustrated embodiment the back cover 14 of the bound component 10 includes a spring clip 46 which can releasably retain the marker 28 therein. In this manner, the bound component 10 may be able to carry the marker 28, including the writing tip 30, erasing tip 32 and/or absorbent portion(s) 28, with the bound component 10 for easy and convenient use and storage. Of course, the marker 28 may be able to be coupled to various other locations of the bound component 10, including the front cover 12, pages 18, binding mechanism 16, insert 20, etc. In addition, a wide variety of retaining mechanisms besides the spring clip 46, such as loops, portions of hook-and-loop fastening material, cut-outs, openings or the like may be utilized to releasable couple the marker 28 to the bound component 10.

Although the invention is shown and described with respect to certain embodiments, it is obvious that variations and modifications will occur to those skilled in the art upon reading the specification. The present invention includes all such variations and modifications and is limited only by the scope of the claims.

What is claimed is:

1. A calendar system comprising:
a bound component including a plurality of sheets of paper and a binding mechanism binding said plurality of sheets together, wherein each sheet includes a calendar portion printed thereon, each calendar portion of each sheet being of substantially the same size and format;
a generally translucent insert configured to be directly releasably coupled to said binding mechanism such that said insert is positionable on top of one of said sheets such that said calendar portion of said underlying sheet is visible through said insert;
a permanent writing instrument configured to dispense permanent markings on said insert when said insert is written upon by said writing instrument; and
erasing means for erasing permanent markings from said insert, wherein said writing instrument is operable to write indicia on said insert such that said indicia written on said insert is usable in conjunction with calendar portions of various ones of said sheets when said insert is attached to said binding mechanism and positioned on top of various ones of said sheets.

2. The system of claim 1 wherein said writing instrument and insert are usable such that a recurring reminder is writeable on said insert which recurring reminder is positioned to relate to a day or time period on said underlying sheet, and wherein said insert is positionable on top of another one of said sheets such that said recurring reminder is positioned to relate to said day or time period for said calendar portion of said another one of said sheets.

3. The system of claim 1 wherein said insert is configured such that when said insert is directly releasably coupled to said binding mechanism and positioned on top of said underlying sheet said insert substantially entirely covers said underlying sheet.

4. The system of claim 1 wherein said insert is made of a polymer material.

5. The system of claim 1 wherein said writing instrument is releasably attached to said bound component.

6. The system of claim 1 wherein said erasing means is directly coupled to said writing instrument.

7. The system of claim 1 wherein said permanent writing instrument is configured to dispense a solvent based permanent ink.

8. The system of claim 7 wherein said erasing means is configured to dispense said solvent and wherein said insert is made of a polymeric material that is chemically resistent to said solvent.

9. The system of claim 1 wherein said permanent markings generally resist removal by soap and water.

10. The system of claim 1 wherein said insert is made of polypropylene or polyethylene.

11. The system of claim 1 wherein said insert has an average surface roughness of between about 50 and about 1000 microns.

12. The system of claim 1 wherein said plurality of sheets have a width dimension extending generally perpendicular to said binding mechanism, and wherein said insert has a tab portion configured such that said tab insert protrudes outwardly from said plurality of sheets when said insert is directly coupled to said binding mechanism.

13. The system of claim 1 wherein said binding mechanism is a coil wire or spiral wire binding mechanism.

14. The system of claim 13 wherein said insert includes a plurality of openings along an outer edge thereof, each opening being configured to receive at least one turn of said coil wire or spiral wire binding mechanism therein to directly releasably couple said insert to said binding mechanism.

15. The system of claim 1 further comprising a cover made of a polymer material that is bound to said plurality of sheets by said binding mechanism, and wherein said cover is configured to receive permanent markings thereon from said writing instrument, and wherein said permanent markings on said cover are erasable by said erasing means.

16. A system comprising:
a bound component comprising a plurality of sheets of paper and a binding mechanism binding said plurality of sheets together;
an insert configured to be directly releasably coupled to said binding mechanism such that said insert is positioned on top of one of said sheets and substantially entirely covers said underlying sheet;
a permanent writing instrument configured to dispense permanent markings on said insert when said insert is written upon by said writing instrument; and
erasing means for erasing permanent markings from said insert.

17. The system of claim 16 wherein each sheet includes a calendar portion printed thereon, and wherein said insert is configured to cover said calendar portion of each sheet.

18. The system of claim 17 wherein said insert is generally translucent such that when said insert is positioned on top of said one sheet said calendar portion of said one sheet is visible through said insert.

19. The system of claim 16 wherein said erasing means is directly coupled to said writing instrument and said writing instrument is releasably attached to said bound component.

20. The system of claim 16 wherein said permanent writing instrument is configured to dispense a solvent based permanent ink such that said permanent markings generally resist removal by soap and water, and wherein said erasing means is configured to dispense said solvent and wherein said insert is made of a polymeric material that is chemically resistent to said solvent.

21. A calendar system comprising:
a bound component comprising a plurality of sheets of paper and a binding mechanism binding said plurality of sheets together, wherein each sheet includes a calendar portion printed thereon of substantially the same size and format;
an insert configured to be directly releasably coupled to said binding mechanism such that said insert is positionable on top of one of said sheets and substantially entirely covers said calendar portion of said underlying sheet, wherein said insert is at lest partially translucent such that the calendar portion of the underlying sheet is generally visible therethrough; and
a writing instrument configured to dispense markings on said insert when said insert is written upon by said writing instrument such that a recurring reminder is writeable on said insert with said writing instrument, which recurring reminder is positioned to relate to a day or time period on said underlying sheet, and wherein said insert is positionable on top of another one of said sheets such that said recurring reminder is positioned to relate to said specific day or time period for said calendar portion of said another one of said sheets.

22. The calendar system of claim 21 wherein said writing instrument is configured to dispense a solvent-based permanent ink, and wherein said writing instrument is configured to dispense a solvent-based erasing solution.

23. A method for using a calendar system comprising:
accessing a bound component system including a plurality of sheets of paper, each sheet including a calendar portion printed thereon, said bound component system further including a binding mechanism binding said plurality of sheets together, a generally translucent insert, and a permanent writing instrument configured to dispense permanent markings on said insert when said insert is written upon by said writing instrument, said writing instrument including erasing means for erasing permanent markings from said insert;
directly releasably coupling said insert to said binding mechanism such that said insert is positioned on top of a first one of said sheets such that said calendar portion of said first one of said sheets is visible through said insert;
writing indicia on said insert with said writing instrument, wherein said indicia is associated with a day or time period of said visible calendar portion of said first one said one sheets;
detaching said insert from said binding mechanism; and
directly releasably coupling said insert to said binding mechanism at another location of said bound component such that said insert is positioned on top of a second one of said sheets such that said calendar portion of said second one of said sheets is visible through said insert and said indicia is associated with a day or time period of said second one of said sheets that corresponds to said day or time period of said first one of said sheets.

24. A method for using a calendar system comprising:
accessing a bound component system including a plurality of sheets of paper, each sheet including a calendar portion printed thereon, said bound component system further including a binding mechanism binding said plurality of sheets together, an insert, and a writing instrument configured to dispense markings on said insert;
directly releasably coupling said insert to said binding mechanism such that said insert is positioned on top of a first one of said sheets, wherein said insert is at least partially translucent such that said calendar portion of said first one of said sheets is visible through said insert;
writing indicia on said insert with said writing instrument, wherein said indicia is associated with a day or time period of said visible calendar portion of said first one of said sheets;
detaching said insert from said binding mechanism; and
directly releasably coupling said insert to said binding mechanism at another location of said bound component such that said insert is positioned on top of a second one of said sheets such that said calendar portion of said second one of said sheets is visible through said insert and said indicia is associated with a day or time period of said second one of said sheets that corresponds to said day or time period of said first one of said sheets.
